(19) United States
(12) Patent Application Publication
(10) Pub. No.: US 2005/0281402 A1
(43) Pub. Date: Dec. 22, 2005

(54) Automatic entrance station answering apparatus and method

(76) Inventor: Oren Petrank, Haverfordwest (GB)

Correspondence Address: OREN PETRANK, 83 AUGUSTINE WAY, HAVERFORDWEST, SA61 INZ, GB

(21) Appl. No.: 10/988,488

(22) Filed: Nov. 15, 2004

(30) Foreign Application Priority Data
Aug. 19, 2004 (GB) 0418571.6
May 11, 2004 (GB) 0410368.7
Jan. 12, 2004 (GB) 0400507.0
May 22, 2002 (GB) 0211708.3

(51) Int. Cl. H04M 1/60; H04M 1/64

(52) U.S. Cl. 379/167.04; 379/88.16

(57) ABSTRACT

With the need to increase the efficiency of automatic communication systems, the introduction of ‘automatic dialogue’, by the use of pre-recorded messages, through Intercom/Entrance station systems has become an urgently needed new technology. This patent application addresses this need. In this patent application the term ‘automatic dialogue’ refers to the interaction between the Caller and the Entrance Station whereby the Caller operates the various input means, such as Caller's operated buttons, and the Entrance Station automatically responds by playing pre-recorded and displayed messages. This patent application discloses the inventive concept of ‘automatic dialogue’ with a visitor through an Intercom/Entrance Station by the use of pre-recorded messages. This application consolidates the various features previously disclosed in patent applications GB0418571.6, GB0416755.7, GB0416450.5, GB0410368.7, GB0319437.0, GB0320758.6, GB0322537.2, GB0400507.0 and GB0211708.3. According to the invention thereby provided an Apparatus and Method comprising an Entrance Station having Caller's input means, such as Caller's operated buttons, with the means to recognize each signal that is produced by operating each input means, such as pressing each button, that facilitates ‘automatic dialogue’, a multi level response from the Caller, by employing repeatedly the following functions in the following order: (a) Recognize each signal that is produced, when the Caller operates each input means, such as pressing each button on the Entrance Station (b) Use the said signal to provide the link to a pre-recorded message to be played (c) Play the said pre-recorded message. This patent application discloses the inventive concept of automatically and repeatedly displaying message/s on the Entrance Station's Monitor in response to the Caller's operating the input means, such as pressing the buttons, on the Entrance Station. Other features are disclosed such as the recording and storing the Caller's voice, the Caller's choice of the Language of the pre-recorded messages and displayed messages, the facility to connect the Caller to a person on the Called Party's premises, automatically hinder or approve Entry or Exit, to or from the Called Party's premises. Other features include the facility to allow the Caller to input more complex forms of information, the means to recognize absorb and store the Caller's Skin patterns, images of the Caller's Face and Body, images of the Caller's Eye Retina. This invention opens new doors to future uses of Entrance Station/Intercom systems in domestic, industrial, business premises, or institutional settings.

### BACKGROUND OF THE INVENTION

With the need to increase the efficiency of automatic communication systems, the introduction of ‘automatic dialogue’, by the use of pre-recorded messages, through Intercom/Entrance station systems has become an urgently needed new technology. This patent application addresses this need. In this patent application the term ‘automatic dialogue’ refers to the interaction between the Caller and the Entrance Station whereby the Caller operates the various input means, such as Caller's operated buttons, and the Entrance Station automatically responds by playing pre-recorded and displayed messages.

### SUMMARY OF THE INVENTION

This patent application discloses the inventive concept of ‘automatic dialogue’ with a visitor through an Intercom/Entrance Station by the use of pre-recorded messages. This application consolidates the various features previously disclosed in patent applications GB0418571.6, GB0416755.7, GB0416450.5, GB0410368.7, GB0319437.0, GB0320758.6, GB0322537.2, GB0400507.0 and GB0211708.3. According to the invention thereby provided an Apparatus and Method comprising an Entrance Station having Caller's input means, such as Caller's operated buttons, with the means to recognize each signal that is produced by operating each input means, such as pressing each button, that facilitates ‘automatic dialogue’, a multi level response from the Caller, by employing repeatedly the following functions in the following order: (a) Recognize each signal that is produced, when the Caller operates each input means, such as pressing each button on the Entrance Station (b) Use the said signal to provide the link to a pre-recorded message to be played (c) Play the said pre-recorded message. This patent application discloses the inventive concept of automatically and repeatedly displaying message/s on the Entrance Station's Monitor in response to the Caller's operating the input means, such as pressing the buttons, on the Entrance Station. Other features are disclosed such as the recording and storing the Caller's voice, the Caller's choice of the language of the pre-recorded messages and displayed messages, the facility to connect the Caller to a person on the Called Party's premises, automatically hinder or approve Entry or Exit, to or from the Called Party's premises. Other features include the facility to allow the Caller to input more complex forms of information, the means to recognize absorb and store the Caller's Skin patterns, images of the Caller's Face and Body, images of the Caller's Eye Retina. This invention opens new doors to future uses of Entrance Station/Intercom systems in domestic, industrial, business premises, or institutional settings.

### INTRODUCTION TO THE DRAWINGS

FIG. 1/3 Illustrates possible types of Equipment that can be used to allow various levels of Control, Interface and Interaction between the Caller and the Caller's operated input means on the Entrance Station.

FIG. 2/3 Illustrates an Entrance Station situated at the Entry to or Exit from the Called Party's premises.

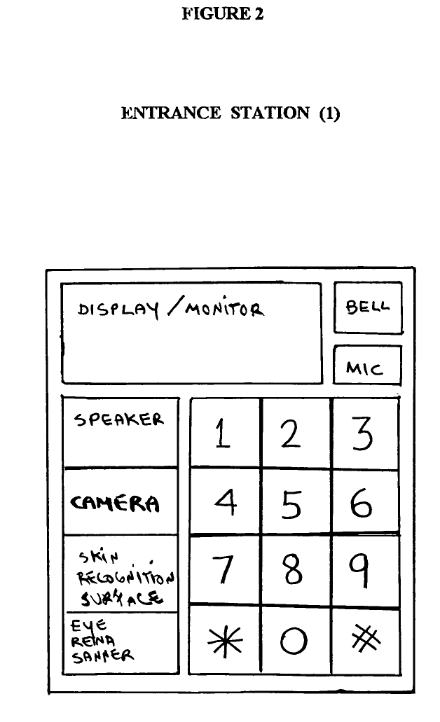

FIG. 3/3 Illustrates an Entrance Station situated at the Entry to or Exit from the Called Party's premises.

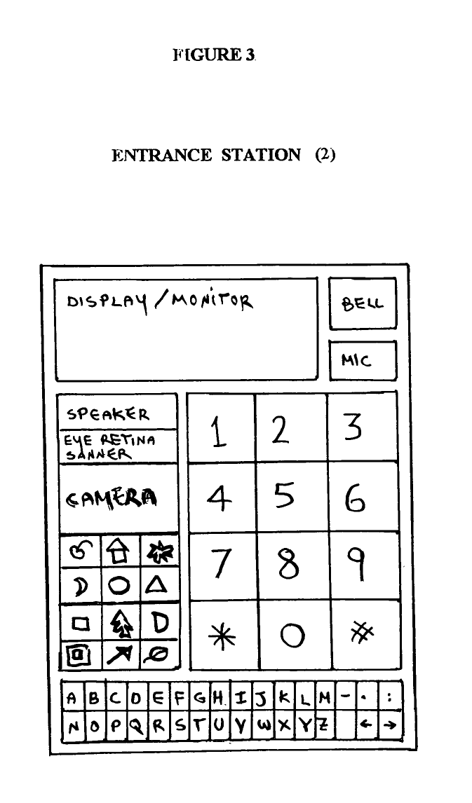

### EXAMPLES

(1) The Called Party, a private householder, wish to welcome all visitors, with a pre-recorded message when they press the Bell or Call button (or other suitable input means) on the Entrance Station, at the Entrance to the Called Party's residence, as well as an invitation on the Entrance Station's Display.

The visitor is asked to respond to the pre-recorded message by operating the input means, such as Caller's operated buttons, to confirm the choice of Language:

Press (touch) 1 if you speak English

Press (touch) 2 if you speak French

The following pre-recorded message to be automatically played:

Press (touch) 1 if you personally know who you are calling on

Press (touch) 2 if you personally do not know who you are calling on

If press 1: Play a pre-recorded message asking the Caller to type the name of the person, the Caller wish to see, on the Entrance Station's Keyboard,

If the typed name matches the name of the householder:

Automatically connect to the householder to permit normal conversation.

If the typed name does not match the name of the householder, automatically move to respond as if option 2 was chosen.

If pressed 2:

Press (touch) 1 if you wish to see this person for a business reason

Press (touch) 1 if you wish to see this person for a family reason

Press (touch) 1 if you wish to see this person for a social reason

Press (touch) 1 if you wish to see this person for any other reason

The following pre-recorded message to be automatically played:

Please state your name and telephone number for the Called Party to return your call.

(2) The Called Party is a business complex that houses a few dozen tenants and has a central security and access system in place.

All callers can avail themselves to a ‘private reception cubical’ that permit each caller to privately interact with an Entrance Station described in this application. The Caller, by responding to the various options presented by means of pre-recorded messages and displayed messages, can navigate through a chain of questions and options, before the Caller is directed, by means of a pre-recorded message and displayed diagram, to the location (within the business complex) of the premises of the desired Tenant. The Entrance Station can permit the Caller, at the end of the automatic screening process, to converse directly with a person on the renant's premises, who is able to permit the Caller to enter the premises by disabling an entrance control barrier by remote control. The same procedure is repeated before the Caller is authorized to exit the business Complex.

(3) The Called Party is a government building that houses many departments.

Each Caller is required to interact with an Entrance Station to disclose the Caller's identity, including Eye Retina scan, before directions are give as to the location of the required department within the building, and automatically disable of an access control barrier to permit the Caller to enter. The same procedure is repeated before the Caller is authorized to exit the Building.

(4) The Called Party is a Hospital that requires to monitor the Entry and Exit for all visitor and prevent any unauthorized person from leaving the Hospital premises before they are personally examined by a security guard.

By the use of Entrance Station apparatus and method described in this application, and by employing a computer (microprocessor) system that contains the Data Base of previous, current and expected Callers, it is possible to automatically verify the identify of each Caller, by obtaining the relevant information before Entry and automatically comparing it the the existing data within the Data Bank, and thereby prevent unauthorized person from entry. The system may allow Entry but hinder automatic Exit, thereby compelling the Caller to be personally examined by a security guard before Exit is permitted.

### Automatic Enternace Station Answerng Apparatus and Method

### DETAILED DESCRIPTION OF THE INVENTION

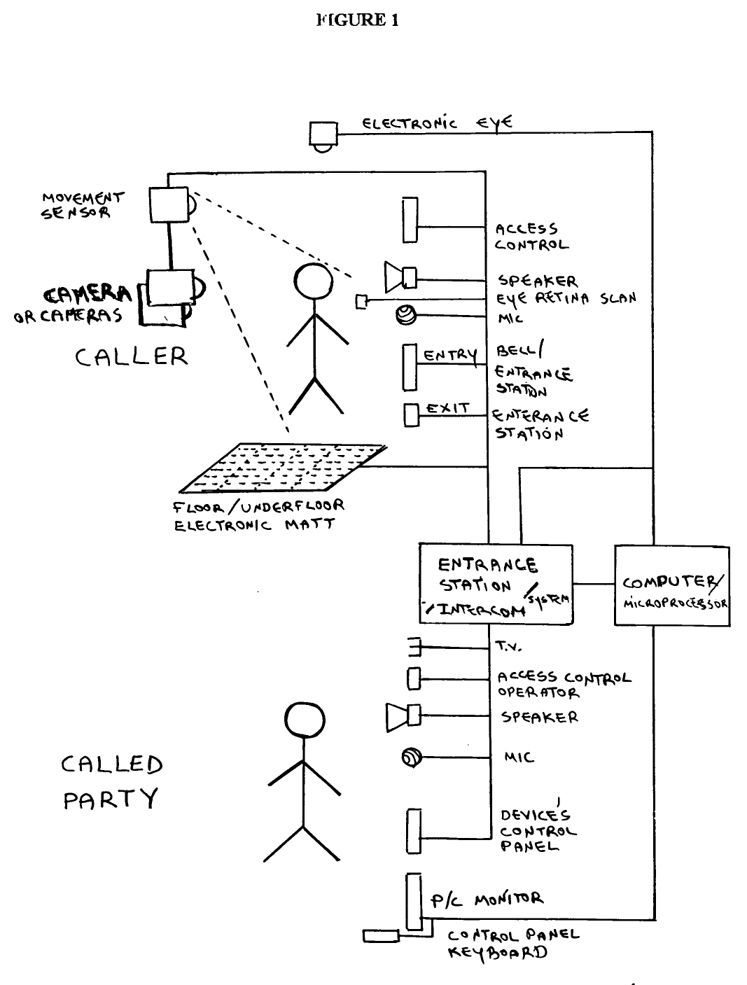

The apparatus and method can be operated through the use of the following FEARURES or COTROLS that enable the operations contained in the description and examples previously sited. The following are the NAMES of the features or controls that make up the automatic Entrance Station/Intercom answering apparatus and method.
1-9,0, Caller's operated input means, such as Caller's operated buttons, made up of
A to Z Numbers, Letters, Symbols or any combination of two or three types. These
Symbols controls, on the Entrance Station, that may be arranged in the form of a Keyboard, can be used by the Caller to respond to the pre-recorded message/s and or displayed messages on the Entrance Station's Monitor.
Memory Contains all the instructions, programs to facilitate ‘automatic dialogue’ and other features of automatic communication system/s, memory cells, stored pre-recorded message/s, temporary storage of signals and responses [to facilitate the link to the follow up prerecorded and or displayed message/s], storage of the information that the ‘press button’ options (or operation of input means) represent, all information gathered from the Caller by the use of the Entry and or Exit Entrance Station(s), including the results of the Eye Retina scans, images of the Caller's Skin patterns, images and photographs of the Caller's Body or Face.
Telephone Allows for the integration of the Entrance Station apparatus and method
System into the Called Party's Internal telephone exchange.
Language Permit the Caller to select the Language of his or her choosing in which the pre-recorded messages are to be played, and in which the information on the Entrance Station's Monitor is to be displayed. That can be done by means of ‘press button’ responses, use of a Keyboard or any other means.
Computer/Allows the integration of the Entrance Station apparatus and method
Microprocessor into a Computer system or Microprocessor system that facilitates
System ‘automatic dialogue’ with the Caller, by means of pre-recorded messages, and or displayed messages on the Entrance Station's Monitor. The computer system makes it possible to store and analyze the information gathered by means of the Automatic Entrance Station described in this patent application.
Access This option allows automatic or manual annulment of an access control
Control barrier that can prevent the Caller from Entering or leaving the Called Party's premises.
Skin This option allows the recognition and absorption of the image/s of the
Recognition Skin Patterns of the Caller by means of skin contact with the designated
Unit surface on the Entrance Station, and the storage of these image/s.
Eye Retina Allows the scanning of the Caller's Eye Retina and the storage of the
Scanner results of the scan.
Camera/s Auto photography or recording of the Caller's Body or Face by means of a camera or cameras, using any technology, including digital technology and the storing of these images or photographs.
Options The Called Party can select any of the following methods:
   (1) Permit the Caller to select the Language of his or her choosing in which the pre-recorded messages are to be played, and the Language in which information displayed on the Entrance Station's Monitor.
   (2) Play a pre-recorded message, and or display a message on the Entrance Station's Monitor, and allow the Caller to respond by means of recording his own voice message, and or type a message by using the Caller's buttons or other Caller's operated means on the Entrance Station.
   (3) Play a pre-recorded message, and or display a message on the Entrance Station's Monitor, and allow the Caller to respond by means of a single operation [press, touch ] of the Caller's operated buttons, or other input means, in each response cycle.
   (4) Play a pre-recorded message, and or display a message on the Entrance Station's Monitor, and allow the Caller to respond by means of multiple operations [press, touch] of the Caller's operated buttons, or other input means, in each response cycle.
   (5) Play a pre-recorded message, and or display a message on the Entrance Station's Monitor, and allow the Caller to respond by means of single or multiple operations [press, touch] of the Caller's operated buttons, or other input means, that are marked as ‘Numbers’ in each response cycle.
   (6) Play a pre-recorded message, and or display a message on the Entrance Station's Monitor, and allow the Caller to respond by means of single or multiple operations [press, touch] of the Caller's operated buttons, or other input means, that are marked as ‘Letters’ in each response cycle.
   (7) Play a pre-recorded message, and or display a message on the Entrance Station's Monitor, and allow the Caller to respond by means of single or multiple operations [press, touch] of the Caller's operated buttons, or other input means, that are marked as ‘Letters’ in each response cycle.
   (8) Play a pre-recorded message, and or display a message on the Entrance Station's Monitor, and allow the Caller to respond by means of single or multiple operations [press, touch] of the Caller's operated buttons, or other input means, that are marked as ‘Symbols’ in each response cycle.
   (9) Play a pre-recorded message, and or display a message on the Entrance Station's Monitor, and allow the Caller to respond by means of multiple operations [press, touch] of the Caller's operated buttons, or other input means, that consist of any combination or sequence of ‘Numbers’, ‘Letters’, ‘Symbols’ or either two or three Types in any in response cycle.
   (10) Play a pre-recorded message, and or display a message on the Entrance Station's Monitor, and allow the Caller to respond by means of Caller's operating buttons [press, touch ], or other input means, to facilitate the repetition of the last pre-recorded message that was automatically played for the benefit of the Caller.
   (11) Play a pre-recorded message, and or display a message on the Entrance Station's Monitor, and allow the Caller to respond in any other way, such as permit skin contact with a designated surface, submit to an Eye Retina scan, permit automatic photography or submit to automatic process of obtaining images of the Caller's Body and or Face, or any other information that can be used to unmistakably identify the Caller.
   (12) Play a pre-recorded message, and or display a message on the Entrance Station's Monitor, to allow the Caller to respond in any of the above mentioned manners and allows the response from the Caller to trigger the playing of further pre-recorded message, and or the displaying of a message on the Entrance Station's Monitor, and further response/s in repeated cycles as determined by the Called Party.
Input As the Caller operates the means of input, such as Caller's operated buttons,
Means the Entrance Station Apparatus and Method is able to recognize the signal that is produced by pressing each button, and then use the said signal to provide the link to the pre-recorded message to be played, and or the message to be displayed on the Entrance Station's Monitor.
Entrance This Instrument panel, as shown in FIGS. 1/3;2/3;3/3, made up of
Station Caller's operated input means, such as Caller's operated Buttons.
The said buttons, can be marked as ‘Numbers’, ‘Letters’, ‘Symbols’ The Entrance Station, Instrument Panel, can be made up of Speakers, Microphone, Display or Monitor, Keyboard, Skin Recognition unit, Camera/s, Eye Retina Scanner, Keyboard or any other Caller's operated input means. It can facilitate automatic communication between the Called Party and the Caller, by means of automatic playing of pre-recorded message/s and or displayed message/s on the Entrance Station's Monitor. It can also facilitate a response from the Caller, by operating the Caller's operated buttons, and thereby make possible an ‘automatic dialogue’ between the Called Party and the Caller.
   The Caller's repeated response to the playing of pre-recorded and or displayed message/s, may continue for a number of cycles, as described earlier under ‘Options’. The Entrance Station can facilitate normal communication between the Caller and the Called Party as the Caller responds to the ‘automatic dialogue’. The Entrance Station can be placed in the vicinity of the Entrance to the Called Party's premises and or the vicinity of Exit from the Called Party's premises.
Automatic This method facilitates automatic trigger to the playing of the first
Message pre-recorded or a displayed message in response to the presence of a Caller
Trigger that can be detected by means of an electronic movement sensor, electronic eye or electronic Matt.
Automatic As the Caller operates the Caller's operated input means, such as Caller's
Traffic operated buttons, in response to the playing of prerecorded message/s
Control an automatic function, hereby described as ‘automatic traffic control’, can trigger a communication channel with a person on the Called Party's premises that is suitable to deal with the concern/s, requirements or needs of the Caller.

1. An Apparatus comprising an Entrance Station, having input means, Caller's operated buttons, with the means to recognize each signal, that is produced by pressing each button, that automatically play a pre-recorded message and facilitates a multi level response from the Caller by employing repeatedly the following functions in the following sequence:
(a) Recognize each signal, that is produced when the Caller presses each of the buttons on the Entrance station;
(b) Use the said signal to provide the link to a pre-recorded message to be played;
(c) Play the said pre-recorded message.

2. An Apparatus as claimed in claim 1 comprising an Entrance Station, having input means, Caller's operated buttons, with the means to recognize each signal, that is produced by pressing each button, that automatically play a pre-recorded message and facilitates a multi level response from the Caller by employing repeatedly the following functions in the following sequence:
(a) Recognize each signal, that is produced when the Caller presses each of the buttons on the Entrance station;
(b) Use the said signal to provide the link to a pre-recorded message to be played;
(c) Play the said pre-recorded message;
(d) Record and Store the voice of the Caller.

3. An Apparatus as claimed in claims 1 or 2 that permits the Caller to choose the language in which pre-recorded message/s is/are to be played.

4. An Apparatus as claimed in claims 1, 2 or 3 that is able to automatically trigger the playing of a pre-recorded message in response to the presence of a Caller, by means of an electronic Matt, electronic Eye, Movement sensor.

5. An Apparatus comprising an Entrance Station, having input means, Caller's operated buttons and an Entrance Station's Monitor, with the means to recognize each signal, that is produced by pressing each button, that automatically display a message on the Entrance Station's Monitor and facilitates a multi level response from the Caller by employing repeatedly the following functions in the following sequence:
(a) Recognize each signal that is produced when the Caller presses each of the buttons on the Entrance station;
(b) Use the said signal to provide the link to a message to be displayed;
(c) Display the said message on the Entrance Station's Monitor.

6. An Apparatus as claimed in claim 5 comprising an Entrance Station, having input means, Caller's operated buttons and an Entrance Station's Monitor, with the means to recognize each signal, that is produced by pressing each button, and facilitates a multi level response from the Caller by employing repeatedly the following functions in the following sequence:
(a) Recognize any combination/sequence of signal that is produced when the Caller presses any combination/sequence of buttons on the Entrance station;
(b) Use the said signals to provide the link to a message to be displayed;
(c) Display the said message on the Entrance Station's Monitor.

7. An Apparatus as claimed in claims 5 or 6 that permits the Caller to choose the language in which message/s is/are to be displayed.

8. An Apparatus as claimed in claims 5, 6 or 7 that is able to automatically trigger the displaying of a message, on the Entrance Station's Monitor, in response to the presence of a Caller, by means of an electronic Matt, electronic Eye, Movement sensor.

9. An Apparatus, as claimed in any of the preceding claims, that is located in the vicinity of the Entrance to the Called Party's premises.

10. An Apparatus, as claimed in any of the preceding claims, that is located in the vicinity of the Exit from the Called Party's premises.

11. An Apparatus, as claimed in any of the preceding claims, that is located in the vicinity of the Entrance to, and the Exit from, the Called Party's premises.

12. An Apparatus as claimed in any of the preceding claims that is equipped with the means to enable/disable an access control barrier to permit/prevent the entry/exit of the Caller to/from the Called Party's premises.

13. An Apparatus as claimed in any of the preceding claims, having Caller's operated buttons, with the means to recognize each signal that is produced by pressing each button, and the means to store the result of the signal, the information that each signal represents.

14. An Apparatus as claimed in any of the preceding claims, having Caller's operated buttons, with the means to recognize any combination/sequence of signals that is produced by pressing any combination/sequence of buttons, and the means to store the result/s of the signals, the information that each combination/sequence of signals represents.

15. An Apparatus as claimed in any of the preceding claims with the means to recognize, absorb and store image/s of the Caller's skin patterns, photograph, absorb and store images of the Caller's body, the Caller's face, the Caller's eye Retina.

16. An Apparatus as claimed in any of the preceding claims that is able to automatically connect the Caller, by means of an Internal telephone system, to a telephone instrument, to allow normal conversation with a person on the Called Party's premises.

17. An apparatus or method as claimed in any of the preceding claims that has Caller's operated buttons marked with symbols.

18. An Apparatus as claimed in any of the preceding claims that is equipped with a computer/microprocessor system, that contains the Database of current, previous, expected Callers that is able to compare the data and information obtained from the Caller to the information in the said Data Base in order to verify the identity of the Caller and automatically enable/disable an access control barrier, to permit/prevent the Caller's entry/exit to/from the Called Party's premises.

19. An apparatus that is substantially the same as what is described in this patent application.

20. A method that is substantially the same as what is described in this patent application.
